(19) United States
(12) Patent Application Publication
(10) Pub. No.: US 2014/0320471 A1
(43) Pub. Date: Oct. 30, 2014

(54) DRIVING METHOD AND PIXEL UNIT OF ACTIVE MATRIX ORGANIC LIGHT-EMITTING DIODE PANEL

(71) Applicant: Shenzhen China Star Optoelectronics Technology Co., Ltd., Shenzhen , Guangdong (CN)

(72) Inventor: Chunhuai Li, Shenzhen City (CN)

(73) Assignee: Shenzhen China Star Optoelectronics Technology Co., Ltd., Shenzhen , Guangdong (CN)

(21) Appl. No.: 14/003,454

(22) PCT Filed: Jun. 26, 2013
(86) PCT No.: PCT/CN2013/078058

§ 371 Date: Sep. 6, 2013

(30) Foreign Application Priority Data
Apr. 26, 2013 (CN) 201310150522.5

(51) Int. Cl. G09G 3/32

(52) U.S. Cl. CPC G09G 3/3258
USPC 345/211; 345/82

(57) ABSTRACT

The present invention provides a driving method and a pixel unit for an AMOLED panel. The driving method includes (1) providing an AMOLED panel, which includes pixel units, each of which includes a row scanning line signal supply unit, a data signal supply unit, a drive voltage supply unit, first and second transistors, a storage unit, and a light emission unit, the first transistor having a first gate terminal and a first source terminal; (2) the data signal supply unit supplying frame image data and a field corresponding to the frame image data is evenly divided into a plurality of sub-fields, the drive voltage supply unit supplying a plurality of drive voltages; (3) the row scanning line signal supply unit outputting a high level and the data signal supply unit applying a control signal to the first transistor, the first gate terminal and the first source terminal forming a voltage difference therebetween, whereby when the voltage differences of the sub-fields are in a high voltage difference zone, the drive voltage supply unit supplies a drive voltage to drive the light emission unit.

### BACKGROUND OF THE INVENTION

1. Field of the Invention

The present invention relates to the display technology of organic light-emitting diode (OLED), and in particular to a driving method and a pixel unit of an active matrix organic light-emitting diode panel.

2. The Related Arts

An organic light-emitting diode (OLED) panel is referred to a thin-film light-emitting device that is made of an organic semiconductor material and is driven by direct current. The principle of light emission of the OLED is that with an indium tin oxide (ITO) transparent electrode and a metal electrode respectively serving as an anode and a cathode, when being driven by a predetermined voltage, electrons, and holes are respectively injected from the cathode and the anode into an electron transportation layer and a hole transportation layer. The electrons and the holes respectively migrate through the electron transportation layer and the hole transportation layer to an emitting material layer and meet each other in the emitting material layer to form excitons, which, through radiation, gives off a visible light.

Methods for driving the OLED can be classified as two types: a passive matrix organic light emitting diode (PMOLED) and an active matrix organic light emitting diode (AMOLED).

Compared to a conventional thin-film transistor liquid crystal display (TFT-LCD), the AMOLED has advantages of high reaction speed, high contrast, wide view angle, richness of color and high brightness, low power consumption, and high/low temperature durability, and may achieve expanded size and enhanced resolution through integration of a TFT and capacitors in each pixel and being driven by using the capacitors to maintain voltage level and are thus considered the next-generation display technology and have already attracted the attention of most of the display technology developers.

An AMOLED panel is driven by a driving circuit to give off light. Referring to FIG. 1, a conventional 2T1C (2TFT1CAP) driving circuit is composed of two TFTs and a storage capacitor C100, in which one of the transistor, M100, is a switching transistor, while the other transistor, M200, is a driving transistor. The transistor M100 is controlled by a unit V_{scan} provided by a row scanning line signal to control an input of a data voltage V_{data}. The transistor M200 functions to control light emission of the OLED. The storage capacitor C100 functions to provide a bias to a gate terminal of the transistor M200 and to maintain voltage level.

For a single cycle of scanning, the operation time of the driving circuit is divided into two parts: the first part being a display data writing period t1. In the display data writing period t1, the row scanning line signal provides a unit V_{scan} that is of a high level and under this condition, the transistor M100 is in an on state, so that the data voltage V_{data} is stored, via a drain terminal and a source terminal of the transistor M100, to the storage capacitor C100. The data voltage V_{data} is applied simultaneously to a gate terminal of the transistor M200, making the transistor M200 operating in a saturated condition to drive the OLED to give off light. The second part is a display sustaining period t2, where the row scanning line signal provides a unit V_{scan} that is of a low level and the transistor M100 is set in an off state thereby cutting off the channel between the drain terminal and the source terminal and preventing the data voltage V_{data} from transmitting to the gate terminal of the transistor M200, namely two ends of the storage capacitor C100. Under this condition, the two ends of the storage capacitor C100 lose the path for releasing charges due to the transistor M100 being cut off and are maintained at the state before the transistor M100 is cut off, keeping the transistor M200 still in the saturated condition to maintain light emission from the OLED. In other words, light emitting from the OLED maintains unchanged during the second part and such a condition continues the transistor M100 is set on again.

In the above method for driving an AMOLED, the luminance of the OLED is: luminance=electrical current×luminous efficiency of OLED, in which “electrical current” indicates the electrical current flowing through the OLED, the magnitude thereof being: electrical current=k(V_{gs}−Vₜₕ)²=k(V_{DD}−V_{data}−Vₜₕ)², where k is a constant associated with the structure and manufacture of the transistor M200, V_{gs} is a voltage difference between the gate terminal and the source terminal of transistor M200, Vₜₕ is a threshold voltage of the transistor M200, and V_{DD} is the voltage supplied from a drive voltage supply unit. From this, it can be seen that the luminance of the AMOLED panel is determined by the magnitude of the data voltage V_{data} and application of different V_{gs} allows the transistor M200 to generate electrical currents of different magnitudes so as to achieve different grey levels. As shown in FIG. 2, which is a time scale diagram illustrating control of grey level purely by means of time in a conventional driving method of an AMOLED, the method uses only time to control grey levels and the shortest charging time of the storage capacitor C100 is 60 ns. However, such a control method may readily causes variation of the drive current of the transistor M200, thus leading to poor consistency of luminance of the AMOLED.

### SUMMARY OF THE INVENTION

An object of the present invention is to provide a driving method for an AMOLED panel, which effectively reduces current variation of a first transistor so as to make the luminance of the AMOLED panel uniform and improve displaying quality.

Another object of the present invention is to provide a pixel unit of an AMOLED, which effectively reduces current variation of a first transistor so as to make the luminance of the AMOLED panel uniform and improve displaying quality.

To achieve the objects, the present invention provides a driving method for an active matrix organic light emitting diode (AMOLED) panel, which comprises the following steps:

(1) providing an AMOLED panel, wherein the AMOLED panel comprises a plurality of pixel units arranged in an array and each of the pixel units comprises: a row scanning line signal supply unit, a data signal supply unit, a drive voltage supply unit, a first transistor, a second transistor, a storage unit, and a light emission unit, the first transistor comprising a first gate terminal, a first drain terminal, and a first source terminal, the second transistor comprising a second gate terminal, a second drain terminal, and a second source terminal, the second gate terminal being electrically connected to the data signal supply unit, the second drain terminal being electrically connected to one end of the storage unit and the first gate terminal of the first transistor, the first drain terminal being electrically connected to the drive voltage supply unit and an opposite end of the storage unit, the first source terminal being electrically connected to the light emission unit, the first gate terminal being electrically connected to said one end of the storage unit and the second drain terminal;

(2) the data signal supply unit supplying frame image data and evenly dividing a field corresponding to each piece of the frame image data into a plurality of sub-fields, the drive voltage supply unit synchronously providing a plurality of drive voltages that is cyclically supplied according to a predetermined order to correspond to the plurality of sub-fields; and

(3) the data signal supply unit charging up the storage unit and applying a control signal to the first gate terminal g of the first transistor, via the second transistor, when the row scanning line signal supply unit outputs a high level, whereby a voltage difference is induced between the first gate terminal and the first source terminal of the first transistor and the drive voltage supply unit supplies a drive voltage that drives the light emission unit when the voltage difference associated with each of the sub-fields is in a high voltage difference zone.

Step (4) is further included after step (3), wherein the second transistor is cut off when the row scanning line signal supply unit outputs a low level, whereby the storage unit acts on the first gate terminal g of the first transistor to set the first transistor in a saturated state so as to keep the light emission unit in the operation condition of the moment when the second transistor gets off.

The storage unit comprises a capacitor. The capacitor has one end electrically connected to the first gate terminal of the first transistor and the second drain terminal of the second transistor and an opposite end electrically connected to the drive voltage supply unit and the first drain terminal of the first transistor. The light emission unit comprises an organic light emitting diode (OLED).

The data signal supply unit supplies an output signal that is “0” or “1”. The high voltage difference zone is 0.9-1 times of an actual voltage supplied from the data signal supply unit when the output signal of the data signal supply unit is “1”.

In step (2), a field corresponding to each piece of the frame image data is evenly divided into eight sub-fields. The eight sub-fields are respectively first to eighth sub-fields. The drive voltage supply unit provides eight drive voltages. The eight drive voltages are respectively first to eighth drive voltage ranging from the smallest to the largest. In step (3), in the first to eighth sub-fields, the first to eighth drive voltages are respectively applied to drive the light emission unit, so that in the first sub-field, the corresponding first drive voltage is applied to drive the light emission unit; in the second sub-field, the corresponding second drive voltage is applied to drive the light emission unit; in the third sub-field, the corresponding drive voltage is applied to drive the light emission unit, and so on; and in the eighth sub-field, the corresponding eighth drive voltage is applied to drive the light emission unit.

The drive voltage supply unit supplies inputs in synchronization with the data signal supply unit and cyclically supplies the first to eighth drive voltages according to the predetermined order.

The present invention also provides a driving method for an AMOLED panel, which comprises the following steps:

(1) providing an AMOLED panel, wherein the AMOLED panel comprises a plurality of pixel units arranged in an array and each of the pixel units comprises: a row scanning line signal supply unit, a data signal supply unit, a drive voltage supply unit, a first transistor, a second transistor, a storage unit, and a light emission unit, the first transistor comprising a first gate terminal, a first drain terminal, and a first source terminal, the second transistor comprising a second gate terminal, a second drain terminal, and a second source terminal, the second gate terminal being electrically connected to the data signal supply unit, the second drain terminal being electrically connected to one end of the storage unit and the first gate terminal of the first transistor, the first drain terminal being electrically connected to the drive voltage supply unit and an opposite end of the storage unit, the first source terminal being electrically connected to the light emission unit, the first gate terminal being electrically connected to said one end of the storage unit and the second drain terminal;

(2) the data signal supply unit supplying frame image data and evenly dividing a field corresponding to each piece of the frame image data into a plurality of sub-fields, the drive voltage supply unit synchronously providing a plurality of drive voltages that is cyclically supplied according to a predetermined order to correspond to the plurality of sub-fields; and

(3) the data signal supply unit charging up the storage unit and applying a control signal to the first gate terminal g of the first transistor, via the second transistor, when the row scanning line signal supply unit outputs a high level, whereby a voltage difference is induced between the first gate terminal and the first source terminal of the first transistor and the drive voltage supply unit supplies a drive voltage that drives the light emission unit when the voltage difference associated with each of the sub-fields is in a high voltage difference zone;

further comprising step (4) after step (3), wherein the second transistor is cut off when the row scanning line signal supply unit outputs a low level, whereby the storage unit acts on the first gate terminal g of the first transistor to set the first transistor in a saturated state so as to keep the light emission unit in the operation condition of the moment when the second transistor gets off;

wherein the storage unit comprises a capacitor, the capacitor having one end electrically connected to the first gate terminal of the first transistor and the second drain terminal of the second transistor and an opposite end electrically connected to the drive voltage supply unit and the first drain terminal of the first transistor, the light emission unit comprising an OLED;

wherein the data signal supply unit supplies an output signal that is “0” or “1”, the high voltage difference zone being 0.9-1 times of an actual voltage supplied from the data signal supply unit when the output signal of the data signal supply unit is “1”;

wherein in step (2), a field corresponding to each piece of the frame image data is evenly divided into eight sub-fields, the eight sub-fields being respectively first to eighth sub-fields, the drive voltage supply unit providing eight drive voltages, the eight drive voltages being respectively first to eighth drive voltage ranging from the smallest to the largest; and in step (3), in the first to eighth sub-fields, the first to eighth drive voltages are respectively applied to drive the light emission unit, so that in the first sub-field, the corresponding first drive voltage is applied to drive the light emission unit; in the second sub-field, the corresponding second drive voltage is applied to drive the light emission unit; in the third sub-field, the corresponding drive voltage is applied to drive the light emission unit, and so on; and in the eighth sub-field, the corresponding eighth drive voltage is applied to drive the light emission unit; and

wherein the drive voltage supply unit supplies inputs in synchronization with the data signal supply unit and cyclically supplies the first to eighth drive voltages according to the predetermined order.

The present invention further provides a pixel unit for an AMOLED panel, which comprises: a row scanning line signal supply unit, a data signal supply unit, a drive voltage supply unit, a first transistor, a second transistor, a storage unit, and a light emission unit. The first transistor comprises a first gate terminal, a first drain terminal, and a first source terminal. The second transistor comprises a second gate terminal, a second drain terminal, and a second source terminal. The second gate terminal is electrically connected to the row scanning line signal supply unit. The second source terminal is electrically connected to the data signal supply unit. The second drain terminal is electrically connected to one end of the storage unit and the first gate terminal of the first transistor. The first drain terminal is electrically connected to the drive voltage supply unit and an opposite end of the storage unit. The first source terminal is electrically connected to the light emission unit. The first gate terminal is electrically connected to said one end of the storage unit and the second drain terminal. The data signal supply unit is a data signal supply unit that supplies frame image data. A field corresponding to each piece of the frame image data comprises a number of identical sub-fields. The drive voltage supply unit is a drive voltage supply unit that supplies a number of drive voltages.

The storage unit comprises a capacitor. The capacitor has one end electrically connected to the first gate terminal of the first transistor and the second drain terminal of the second transistor and an opposite end electrically connected to the drive voltage supply unit and the first drain terminal of the first transistor. The light emission unit comprises an OLED.

The number of identical sub-fields that constitute a field corresponding to each piece of the frame image data is equal to the number of drive voltages that the drive voltage supply unit supplies.

The number of the identical sub-fields that constitute a field corresponding to each piece of the frame image data is eight and the drive voltage supply unit provides eight drive voltages respectively corresponding to the eight sub-fields.

The efficacy of the present invention is that the present invention provides a driving method for an AMOLED, in which a field corresponding to each frame image is evenly divided into a plurality of sub-fields and when V_{gs} of a sub-field of a first transistor is in a high voltage difference zone, a drive voltage supply unit supplies a drive voltage to drive a light emission unit. In other words, in different sub-fields, different drive voltages are applied to drive the light emission unit. The sum of luminance of each sub-field of a frame image is exactly a desired level of luminance. This allows the grey level to be adjusted by means of time and the drive voltage supply unit at the same time and also effectively reduces current variation of the first transistor and overcomes the problem of inhomogeneous luminance of the conventional OLED thereby making the luminance of an AMOLED panel uniform and improving displaying quality. A pixel unit of an AMOLED panel according to the present invention can effectively reduce current variation of the first transistor thereby making the luminance of an AMOLED panel uniform and improving displaying quality.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic diagram of a conventional driving circuit of an active matrix organic light emitting diode (AMOLED) panel;

FIG. 2 is a time scale diagram of a conventional driving method of an AMOLED panel;

FIG. 3 is a flow chart illustrating a driving method for an AMOLED panel according to the present invention;

FIG. 4 is a schematic view showing a pixel unit in the driving method for an AMOLED panel according to the present invention;

FIG. 5 is a time scale diagram illustrating control of grey level with both time and drive voltage in the driving method for an AMOLED panel according to the present invention; and

FIG. 6 is a plot illustrating a first transistor driving a light emission unit in a high voltage difference zone in the driving method for an AMOLED panel according to the present invention.

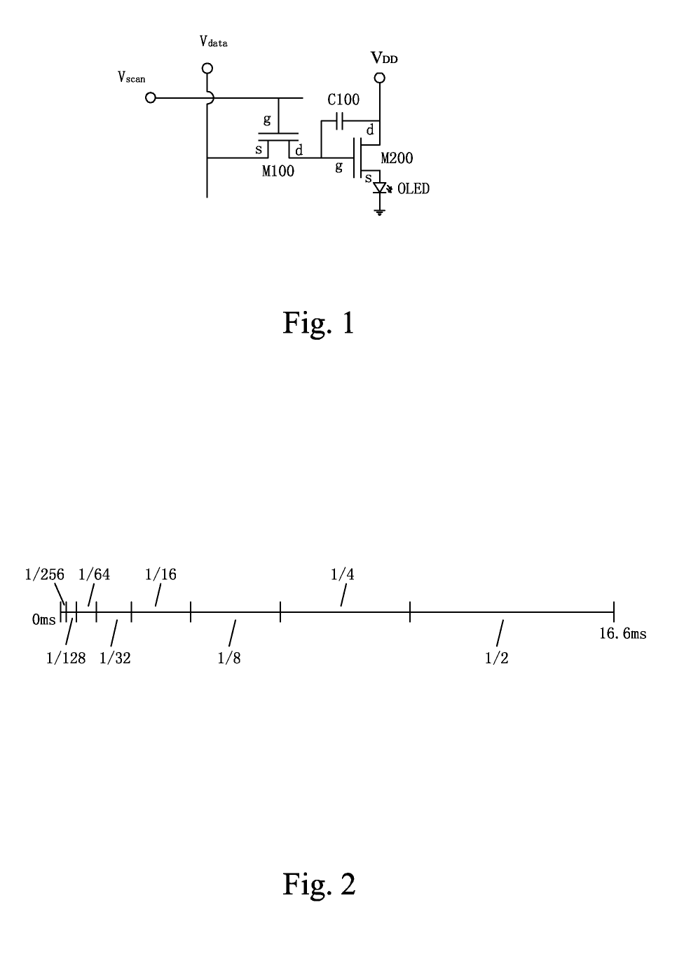

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

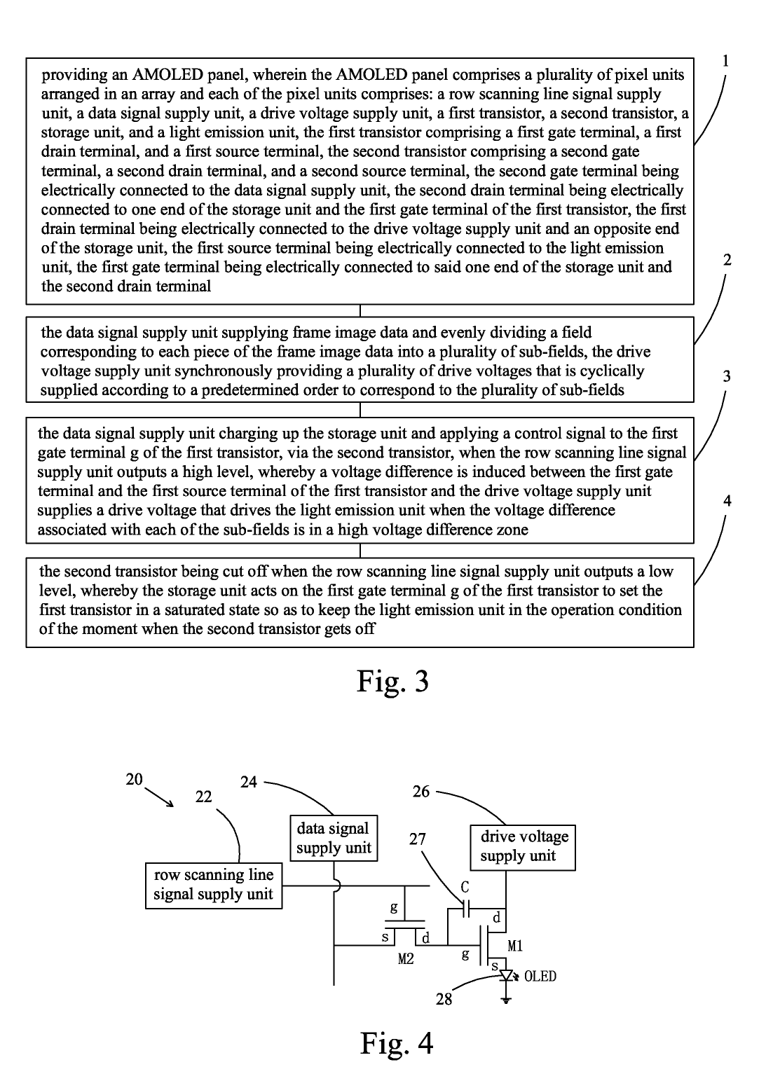

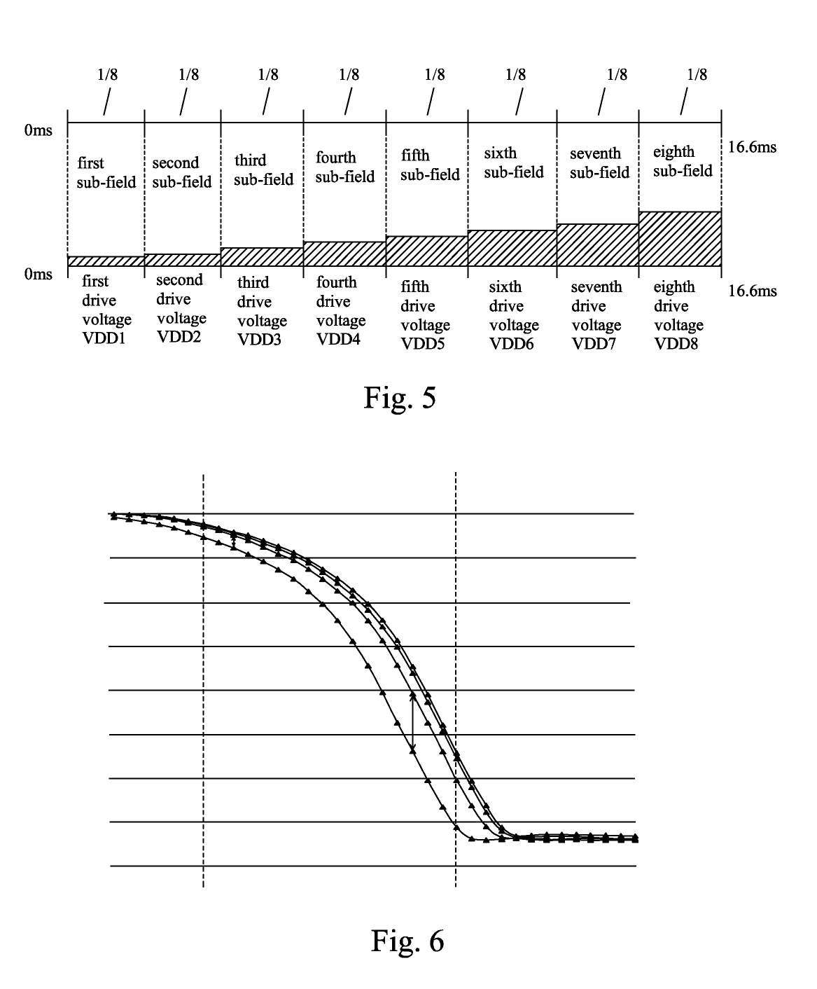

Referring to FIGS. 3-6, the present invention provides a driving method for an AMOLED, which comprises the following steps:

Step 1: providing an active matrix organic light emitting diode (AMOLED) panel, wherein the AMOLED panel comprises a plurality of pixel units 20 arranged in an array and each of the pixel units 20 comprises: a row scanning line signal supply unit 22, a data signal supply unit 24, a drive voltage supply unit 26, a first transistor M1, a second transistor M2, a storage unit 27, and a light emission unit 28.

The first transistor M1 comprises a first gate terminal g, a first source terminal s, and a first drain terminal d. The second transistor M2 comprises a second gate terminal g, a second drain terminal d, and a second source terminal s. The second gate terminal g is electrically connected to the row scanning line signal supply unit 22. The second source terminal s is electrically connected to the data signal supply unit 24. The second drain terminal d is electrically connected to one end of the storage unit 27 and the first gate terminal g of the first transistor M1. The first drain terminal d is electrically connected to the drive voltage supply unit 26 and an opposite end of the storage unit 27. The first source terminal s is electrically connected to the light emission unit 28. The first gate terminal g is electrically connected to the second drain terminal d of the second transistor M2 and said one end of the storage unit 27.

The storage unit 27 is a capacitor C, which functions to provide a bias to the first gate terminal g of the first transistor M1 and maintain voltage level. One end of the capacitor C is electrically connected to the first gate terminal g of the first transistor M1 and the second drain terminal d of the second transistor M2 and an opposite end thereof is electrically connected to the drive voltage supply unit 26 and the first drain terminal d of the first transistor M1. The light emission unit 28 is an organic light emitting diode (OLED), which has an end electrically connected to the first transistor M1 and an opposite end electrically connected to the ground. The OLED has advantages of high luminous efficiency, better effect of power saving, high response speed, and small size.

Step 2: the data signal supply unit 24 supplying frame image data and evenly dividing a field corresponding to each piece of the frame image data into a plurality of sub-fields (SF), the drive voltage supply unit 26 synchronously providing a plurality of drive voltages that is cyclically supplied according to a predetermined order to correspond to the plurality of sub-fields.

The data signal supply unit 24 and the drive voltage supply unit 26 feed in drive signals in synchronization with each other. In the instant preferred embodiment, a field corresponding to each piece of the frame image data is evenly divided into eight sub-fields. The eight sub-fields are respectively first to eighth sub-fields. The drive voltage supply unit 26 provides, in correspondence thereto, eight drive voltages. The eight drive voltages are respectively first to eighth drive voltages, V_{dd1}-V_{dd8}, ranging from the smallest to the largest. Preferably, the first to eighth drive voltages V_{dd1}-V_{dd8} can drive the OLED to give off various levels of luminance, which are respectively 1 (2⁰), 2 (2¹), 4 (2²), 8 (2³), 16 (2⁴), 32 (2⁶), 64 (2⁶), and 128 (2⁷) (namely, the nth drive voltage V_{ddn} drives the OLED to give off luminance of a level of 2ⁿ, where n is an integer that is greater than 0). The eight luminance levels are relative values and combinations of these luminance levels may achieve a desired level of luminance so as to realize various grey levels.

Step 3: the data signal supply unit 24 charging up the storage unit

27 and applying a control signal to the first gate terminal g of the first transistor M1, via the second transistor M2, when the row scanning line signal supply unit 22 outputs a high level, whereby a voltage difference V_{gs} is induced between the first gate terminal g and the first source terminal s of the first transistor M1 and the drive voltage supply unit 26 supplies a drive voltage that drives the light emission unit 28 when the voltage difference V_{gs} associated with each of the sub-fields is in a high voltage difference zone.

With such a manner, the shortest period of time that the data signal supply unit 24 takes to charge up the storage unit 27 via the second transistor M2 can be controlled to be greater than or equal to 2 us, whereby the charging time is extended and the storage unit 27 is well protected to be charged up to a desired voltage thereby preventing current variation of the first transistor M1.

An output signal supplied from the data signal supply unit 24 is a digital signal of “0” or “1” and the high voltage difference zone is preferably 0.9-1 times of the actual voltage supplied from the data signal supply unit 24 when the output signal of the data signal supply unit 24 is “1”. If when the output signal of the data signal supply unit 24 is “1”, the actual voltage supplied from the data signal supply unit 24 is 5V, then the high voltage difference zone is preferably 4.5V-5V.

During the entire operation, the storage unit 27 may get discharging to apply, together with the input signal from the data signal supply unit 24, to the first gate terminal g of the first transistor M1. After the first transistor M1 is turned on, the drive voltage supply unit 26 supplies, at the high voltage difference (V_{gs}) zone of each sub-field, a drive voltage that drives the light emission unit 28 to give off light. In the instant preferred embodiment, in the first sub-field, the first drive voltage V_{dd1} is applied to drive the light emission unit 28; in the second sub-field, the second drive voltage V_{dd2} is applied to drive the light emission unit 28; and so on, in the eights sub-field, the eighth drive voltage V_{dd8} is applied to drive the light emission unit 28. The light emission unit 28 provides a desired luminance through a combination of the lights emitting from the plurality of sub-fields. If a desired level of luminance is 78, since 78=2+4+8+64, it can be appreciated that in such a frame image, it only needs to have the second sub-field exhibiting a luminance level of 2, the third sub-field exhibiting a luminance level of 4, the fourth sub-field exhibiting a luminance level of 8, and the seventh sub-field exhibiting a luminance level of 64. In other words, in such a frame image, it only needs to drive the light emission unit 28 to give off light in the second, third, fourth, and seventh sub-fields and in the remaining sub-fields of the frame image, the light emission unit 28 does not give off light.

Step 4: the second transistor M2 being cut off when the row scanning line signal supply unit 22 outputs a low level, whereby the storage unit 27 acts on the first gate terminal g of the first transistor M1 to set the first transistor M1 in a saturated state so as to keep the light emission unit 28 in the operation condition of the moment when the second transistor M2 gets off.

When the row scanning line signal supply unit 22 outputs a low level, the second transistor M2 is cut off and the storage unit 27 acts on the first gate terminal g of the first transistor M1, setting the first transistor M1 in a saturated state so as to have the light emission unit 28 kept in the operating condition of the moment when the second transistor M2 is set off, such as emitting light, until the second transistor M2 is set on again.

It is noted that the first transistor M1 only drives the light emission unit 28 at the moment when the voltage difference V_{gs} is in the high voltage difference zone. This can effectively reduce current variation of the first transistor M1 and well improve homogenization of images. Further, different drive voltages are used to drive the light emission unit 28 in different sub-fields and the sum of luminance of each sub-field of a frame image is exactly a desired level of luminance. This allows the grey level brightness to be adjusted by means of time and drive voltage at the same time.

Referring to FIGS. 4-6, the present invention also provides a pixel unit 20 for an AMOLED, which comprises: a row scanning line signal supply unit 22, a data signal supply unit 24, a drive voltage supply unit 26, a first transistor M1, a second transistor M2, a storage unit 27, and a light emission unit 28. The first transistor M1 comprises a first gate terminal g, a first source terminal s, and a first drain terminal d. The second transistor M2 comprises a second gate terminal g, a second drain terminal d, and a second source terminal s. The second gate terminal g is electrically connected to the row scanning line signal supply unit 22. The second source terminal s is electrically connected to the data signal supply unit 24. The second drain terminal d is electrically connected to one end of the storage unit 27 and the first gate terminal g of the first transistor M1. The first drain terminal d is electrically connected to the drive voltage supply unit 26 and an opposite end of the storage unit 27. The first source terminal s is electrically connected to the light emission unit 28. The first gate terminal g is electrically connected to the second drain terminal d of the second transistor M2 and said one end of the storage unit 27. The data signal supply unit 24 is a data signal supply unit that supplies frame image data. A field corresponding to each piece of the frame image data comprises a plurality of identical sub-fields. The drive voltage supply unit 26 is a drive voltage supply unit that supplies a plurality of drive voltages. The number of identical sub-fields that constitute a field corresponding to each piece of the frame image data is equal to the number of drive voltages that the drive voltage supply unit 26 can supply.

The data signal supply unit 24 supplies frame image data and a field corresponding to each piece of the frame image data comprises a plurality of identical sub-fields. The drive voltage supply unit 26 provides a plurality of drive voltages, V_{dd}, that corresponds in number to the sub-fields and is cyclically supplied according to a predetermined order. When the row scanning line signal supply unit 22 outputs a high level, the data signal supply unit 24 applies a control signal to the first transistor M1, via the second transistor M2, whereby a voltage difference V_{gs} is induced between the first gate terminal g and the first source terminal s of the first transistor M1. And, when the voltage difference V_{gs} associated with each of the sub-fields is in a high voltage difference zone, the drive voltage supply unit 26 supplies a drive voltage to the light emission unit 28. Thus, current variation of the first transistor M1 can be reduced. Further, in the first sub-field, the first drive voltage V_{dd1} is applied to drive the light emission unit 28; in the second sub-field, the second drive voltage V_{dd2} is applied to drive the light emission unit 28, and so on. Further, during the operation, the storage unit 27 may get discharging to apply, together with an input signal from the data signal supply unit 24, to the first gate terminal g of the first transistor M1. When the row scanning line signal supply unit 22 outputs a low level, the second transistor M2 is cut off and the storage unit 27 acts on the first gate terminal g of the first transistor M1, setting the first transistor M1 in a saturated state so as to have the light emission unit 28 kept in the operating condition of the moment when the second transistor M2 is set off, such as emitting light, until the second transistor M2 is set on again.

An output signal supplied from the data signal supply unit 24 is a digital signal of “0” or “1” and the high voltage difference zone is preferably 0.9-1 times of the actual voltage supplied from the data signal supply unit 24 when the output signal of the data signal supply unit 24 are “1”. If when the output signal of the data signal supply unit 24 is “1”, the actual voltage supplied from the data signal supply unit 24 is 5V, then the high voltage difference zone is preferably 4.5V-5V.

With such an arrangement, the shortest period of time that the data signal supply unit 24 takes to charge up the storage unit 27 via the second transistor M2 can be controlled to be greater than or equal to 2 us, whereby the charging time is extended and the storage unit 27 is well protected to be charged up to a desired voltage thereby preventing current variation of the first transistor M1. The data signal supply unit 24 and the drive voltage supply unit 26 feed in drive signals in synchronization with each other.

Specifically, the storage unit 27 is a capacitor C, which functions to provide a bias to the first gate terminal g of the first transistor M1 and maintain voltage level. One end of the capacitor C is electrically connected to the first gate terminal g of the first transistor M1 and the second drain terminal d of the second transistor M2 and an opposite end thereof is electrically connected to the drive voltage supply unit 26 and the first drain terminal d of the first transistor M1. The light emission unit 28 is an organic light emitting diode (OLED), which has an end electrically connected to the ground. The OLED has advantages of high luminous efficiency, better effect of power saving, high response speed, and small size.

In the instant preferred embodiment, a field corresponding to each piece of the frame image data comprises eight identical sub-fields. The eight identical sub-fields are respectively first to eighth sub-fields. The drive voltage supply unit 26 provides eight drive voltages respectively corresponding to the eight identical sub-fields. The eight drive voltages are respectively first to eighth drive voltages, V_{dd1}-V_{dd8}, ranging from the smallest to the largest. In the first sub-field, the first drive voltage V_{dd1} is applied to drive the light emission unit 28; in the second sub-field, the second drive voltage V_{dd2} is applied to drive the light emission unit 28; and so on, in the eights sub-field, the eighth drive voltage V_{dd8} is applied to drive the light emission unit 28.

Preferably, the first to eighth drive voltages V_{dd1}-V_{dd8} can drive the OLED to give off various levels of luminance, which are respectively 1 (2⁰), 2 (2¹), 4 (2²), 8 (2³), 16 (2⁴), 32 (2⁵), 64 (2⁶), and 128 (2⁷) (namely, the nth drive voltage V_{dd}, drives the OLED to give off luminance of a level of 2ⁿ, where n is an integer that is greater than 0). The eight luminance levels are relative values and combinations of these luminance levels may achieve a desired level of luminance so as to realize various grey levels. If a desired level of luminance is 78, since 78=2+4+8+64, it can be appreciated that it only needs to have the second sub-field exhibiting a luminance level of 2, the third sub-field exhibiting a luminance level of 4, the fourth sub-field exhibiting a luminance level of 8, and the seventh sub-field exhibiting a luminance level of 64. In other words, in the frame image, it only needs to drive the light emission unit 28 to give off light in the second, third, fourth, and seventh sub-fields and in the remaining sub-fields of the frame image, the light emission unit 28 does not give off light. The sum of luminance of each sub-field of a frame image is exactly a desired level of luminance. This allows the grey level brightness to be adjusted by means of time and drive voltage at the same time

In summary, the present invention provides a driving method for an AMOLED, in which a field corresponding to each frame image is evenly divided into a plurality of sub-fields and when V_{gs} of a sub-field of a first transistor is in a high voltage difference zone, a drive voltage supply unit supplies a drive voltage to drive a light emission unit. In other words, in different sub-fields, different drive voltages are applied to drive the light emission unit. The sum of luminance of each sub-field of a frame image is exactly a desired level of luminance. This allows the grey level to be adjusted by means of time and the drive voltage supply unit at the same time and also effectively reduces current variation of the first transistor and overcomes the problem of inhomogeneous luminance of the conventional OLED thereby making the luminance of an AMOLED panel uniform and improving displaying quality. A pixel unit of an AMOLED panel according to the present invention can effectively reduce current variation of the first transistor thereby making the luminance of an AMOLED panel uniform and improving displaying quality.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A driving method for an active matrix organic light emitting diode (AMOLED) panel, comprising the following steps:
(1) providing an AMOLED panel, wherein the AMOLED panel comprises a plurality of pixel units arranged in an array and each of the pixel units comprises: a row scanning line signal supply unit, a data signal supply unit, a drive voltage supply unit, a first transistor, a second transistor, a storage unit, and a light emission unit, the first transistor comprising a first gate terminal, a first drain terminal, and a first source terminal, the second transistor comprising a second gate terminal, a second drain terminal, and a second source terminal, the second gate terminal being electrically connected to the data signal supply unit, the second drain terminal being electrically connected to one end of the storage unit and the first gate terminal of the first transistor, the first drain terminal being electrically connected to the drive voltage supply unit and an opposite end of the storage unit, the first source terminal being electrically connected to the light emission unit, the first gate terminal being electrically connected to said one end of the storage unit and the second drain terminal;
(2) the data signal supply unit supplying frame image data and evenly dividing a field corresponding to each piece of the frame image data into a plurality of sub-fields, the drive voltage supply unit synchronously providing a plurality of drive voltages that is cyclically supplied according to a predetermined order to correspond to the plurality of sub-fields; and
(3) the data signal supply unit charging up the storage unit and applying a control signal to the first gate terminal g of the first transistor, via the second transistor, when the row scanning line signal supply unit outputs a high level, whereby a voltage difference is induced between the first gate terminal and the first source terminal of the first transistor and the drive voltage supply unit supplies a drive voltage that drives the light emission unit when the voltage difference associated with each of the sub-fields is in a high voltage difference zone.

2. The driving method for an AMOLED panel as claimed in claim 1 further comprising step (4) after step (3), wherein the second transistor is cut off when the row scanning line signal supply unit outputs a low level, whereby the storage unit acts on the first gate terminal g of the first transistor to set the first transistor in a saturated state so as to keep the light emission unit in the operation condition of the moment when the second transistor gets off.

3. The driving method for an AMOLED panel as claimed in claim 1, wherein the storage unit comprises a capacitor, the capacitor having one end electrically connected to the first gate terminal of the first transistor and the second drain terminal of the second transistor and an opposite end electrically connected to the drive voltage supply unit and the first drain terminal of the first transistor, the light emission unit comprising an organic light emitting diode (OLED).

4. The driving method for an AMOLED panel as claimed in claim 1, wherein the data signal supply unit supplies an output signal that is “0” or “1”, the high voltage difference zone being 0.9-1 times of an actual voltage supplied from the data signal supply unit when the output signal of the data signal supply unit is “1”.

5. The driving method for an AMOLED panel as claimed in claim 1, wherein in step (2), a field corresponding to each piece of the frame image data is evenly divided into eight sub-fields, the eight sub-fields being respectively first to eighth sub-fields, the drive voltage supply unit providing eight drive voltages, the eight drive voltages being respectively first to eighth drive voltage ranging from the smallest to the largest; and in step (3), in the first to eighth sub-fields, the first to eighth drive voltages are respectively applied to drive the light emission unit, so that in the first sub-field, the corresponding first drive voltage is applied to drive the light emission unit; in the second sub-field, the corresponding second drive voltage is applied to drive the light emission unit; in the third sub-field, the corresponding drive voltage is applied to drive the light emission unit, and so on; and in the eighth sub-field, the corresponding eighth drive voltage is applied to drive the light emission unit.

6. The driving method for an AMOLED panel as claimed in claim 5, wherein the drive voltage supply unit supplies inputs in synchronization with the data signal supply unit and cyclically supplies the first to eighth drive voltages according to the predetermined order.

7. A driving method for an AMOLED panel, comprising the following steps:
(1) providing an AMOLED panel, wherein the AMOLED panel comprises a plurality of pixel units arranged in an array and each of the pixel units comprises: a row scanning line signal supply unit, a data signal supply unit, a drive voltage supply unit, a first transistor, a second transistor, a storage unit, and a light emission unit, the first transistor comprising a first gate terminal, a first drain terminal, and a first source terminal, the second transistor comprising a second gate terminal, a second drain terminal, and a second source terminal, the second gate terminal being electrically connected to the data signal supply unit, the second drain terminal being electrically connected to one end of the storage unit and the first gate terminal of the first transistor, the first drain terminal being electrically connected to the drive voltage supply unit and an opposite end of the storage unit, the first source terminal being electrically connected to the light emission unit, the first gate terminal being electrically connected to said one end of the storage unit and the second drain terminal;
(2) the data signal supply unit supplying frame image data and evenly dividing a field corresponding to each piece of the frame image data into a plurality of sub-fields, the drive voltage supply unit synchronously providing a plurality of drive voltages that is cyclically supplied according to a predetermined order to correspond to the plurality of sub-fields; and
(3) the data signal supply unit charging up the storage unit and applying a control signal to the first gate terminal g of the first transistor, via the second transistor, when the row scanning line signal supply unit outputs a high level, whereby a voltage difference is induced between the first gate terminal and the first source terminal of the first transistor and the drive voltage supply unit supplies a drive voltage that drives the light emission unit when the voltage difference associated with each of the sub-fields is in a high voltage difference zone; and
further comprising step (4) after step (3), wherein the second transistor is cut off when the row scanning line signal supply unit outputs a low level, whereby the storage unit acts on the first gate terminal g of the first transistor to set the first transistor in a saturated state so as to keep the light emission unit in the operation condition of the moment when the second transistor gets off;
wherein the storage unit comprises a capacitor, the capacitor having one end electrically connected to the first gate terminal of the first transistor and the second drain terminal of the second transistor and an opposite end electrically connected to the drive voltage supply unit and the first drain terminal of the first transistor, the light emission unit comprising an OLED;
wherein the data signal supply unit supplies an output signal that is “0” or “1”, the high voltage difference zone being 0.9-1 times of an actual voltage supplied from the data signal supply unit when the output signal of the data signal supply unit is “1”;
wherein in step (2), a field corresponding to each piece of the frame image data is evenly divided into eight sub-fields, the eight sub-fields being respectively first to eighth sub-fields, the drive voltage supply unit providing eight drive voltages, the eight drive voltages being respectively first to eighth drive voltage ranging from the smallest to the largest; and in step (3), in the first to eighth sub-fields, the first to eighth drive voltages are respectively applied to drive the light emission unit, so that in the first sub-field, the corresponding first drive voltage is applied to drive the light emission unit; in the second sub-field, the corresponding second drive voltage is applied to drive the light emission unit; in the third sub-field, the corresponding drive voltage is applied to drive the light emission unit, and so on; and in the eighth sub-field, the corresponding eighth drive voltage is applied to drive the light emission unit; and
wherein the drive voltage supply unit supplies inputs in synchronization with the data signal supply unit and cyclically supplies the first to eighth drive voltages according to the predetermined order.

8. A pixel unit for an AMOLED panel, comprising: a row scanning line signal supply unit, a data signal supply unit, a drive voltage supply unit, a first transistor, a second transistor, a storage unit, and a light emission unit, the first transistor comprising a first gate terminal, a first drain terminal, and a first source terminal, the second transistor comprising a second gate terminal, a second drain terminal, and a second source terminal, the second gate terminal being electrically connected to the row scanning line signal supply unit, the second source terminal being electrically connected to the data signal supply unit, the second drain terminal being electrically connected to one end of the storage unit and the first gate terminal of the first transistor, the first drain terminal being electrically connected to the drive voltage supply unit and an opposite end of the storage unit, the first source terminal being electrically connected to the light emission unit, the first gate terminal being electrically connected to said one end of the storage unit and the second drain terminal, the data signal supply unit being a data signal supply unit that supplies frame image data, a field corresponding to each piece of the frame image data comprising a number of identical sub-fields, the drive voltage supply unit being a drive voltage supply unit that supplies a number of drive voltages.

9. The pixel unit for an AMOLED panel as claimed in claim 8, wherein the storage unit comprises a capacitor, the capacitor having one end electrically connected to the first gate terminal of the first transistor and the second drain terminal of the second transistor and an opposite end electrically connected to the drive voltage supply unit and the first drain terminal of the first transistor, the light emission unit comprising an OLED.

10. The pixel unit for an AMOLED panel as claimed in claim 8, wherein the number of identical sub-fields that constitute a field corresponding to each piece of the frame image data is equal to the number of drive voltages that the drive voltage supply unit supplies.

11. The pixel unit for an AMOLED panel as claimed in claim 8, wherein the number of the identical sub-fields that constitute a field corresponding to each piece of the frame image data is eight and the drive voltage supply unit provides eight drive voltages respectively corresponding to the eight sub-fields.
